(19) United States
(12) Patent Application Publication
(10) Pub. No.: US 2018/0073282 A1
(43) Pub. Date: Mar. 15, 2018

(54) VEHICLE DOOR LOCK APPARATUS

(71) Applicant: ANSEl CORPORATION, Obu-City (JP)

(72) Inventors: Masaharu TAKAGI, Nagoya-City (JP); Satoshi YAMAJI, Nagoya-City (JP)

(21) Appl. No.: 15/813,700

(22) Filed: Nov. 15, 2017

Related U.S. Application Data
(63) Continuation-in-part of application No. 15/456,770, filed on Mar. 13, 2017.

(30) Foreign Application Priority Data
Jul. 15, 2016 (JP) 2016-140590
Jul. 15, 2016 (JP) 2016-140598
Nov. 16, 2016 (JP) 2016-223076

(51) Int. Cl. E05B 79/04; E05B 79/10; E05B 85/04; E05B 85/02

(52) U.S. Cl. CPC E05B 79/04; E05B 85/02; E05B 85/04; E05B 79/10

(57) ABSTRACT

In a vehicle door lock apparatus, first to third attachment holes are formed in a base plate. The first attachment hole is located closer to an entrance of an entry opening than a fork axis in a vehicle inward-outward direction and is located on a first side (fork axis side) of the entry opening in an up-down direction. The second attachment hole is located closer to the entrance than the fork axis in the vehicle inward-outward direction and is located on a second side (pawl axis side) of the entry opening in the up-down direction. The third attachment hole is located between a base of the entry opening and the fork axis in the vehicle inward-outward direction and is also located on the second side (the pawl axis side) of the entry opening in the up-down direction.

### CROSS-REFERENCE

This application is a continuation-in-part of U.S. patent application Ser. No. 15/456,770, which claims the priority benefit of Japanese Patent Application Nos. 2016-140590 and 2016-140598, both filed on Jul. 15, 2016, according to the Paris Convention and 35. U.S.C. 119(a), and this application also claims the priority benefit of Japanese Patent Application Nos. 2016-223076 filed on Nov. 16, 2016, the entire contents of all of which are incorporated by reference as if fully set forth herein.

### TECHNICAL FIELD

The present invention relates to a vehicle door lock apparatus.

### BACKGROUND ART

Japanese Utility Model Publication No. H06-017960 Y2 (hereinafter, “JP H06-017960 Y2”) discloses a known vehicle door lock apparatus that includes a housing, a fork, a pawl, and an actuating mechanism. The housing includes a base plate. An entry opening is formed in the base plate. A striker provided in a vehicle frame can enter the entry opening.

The fork is provided on the base plate so as to be pivotable about a fork axis. The fork is displaceable to a latched position, where the fork retains the striker in the entry opening, and to an unlatched position, where the fork allows the striker to separate from the entry opening. The pawl is provided on the base plate so as to be pivotable about a pawl axis. The pawl axis is located on a first side of the entry opening in the base plate and the fork axis is located on a second (opposite) side of the entry opening. The pawl fixes or releases the fork. The actuating mechanism is provided in the housing. The actuating mechanism acts on the pawl to cause the pawl to release the fork.

As shown in FIG. 1 of JP H06-017960 Y2, a first attachment hole, a second attachment hole, and a third attachment hole are formed in the base plate. The first attachment hole is located closer to an entrance (inlet) of the entry opening (rightward in FIG. 1 of JP H06-017960 Y2) than the fork axis and the pawl axis in a first (left-right) direction in which the entry opening extends. Furthermore, the first attachment hole is located on the fork axis side (upward in FIG. 1 of JP H06-017960 Y2) of the entry opening in a second (up-down) direction that is orthogonal to the first direction and is parallel to the base plate. The second attachment hole is also located closer to the entrance of the entry opening (again, rightward in FIG. 1 of JP H06-017960 Y2) than the fork axis and the pawl axis in the first direction. On the other hand, the second attachment hole is located on the pawl axis side (downward in FIG. 1 of JP H06-017960 Y2) of the entry opening in the second direction. The third attachment hole is disposed on the opposite side of the entrance of the entry opening with respect to the bottom (base) of the entry opening, that is, at a position spaced farther away from the entrance of the entry opening than the bottom (base) of the entry opening in the first direction (i.e. leftward of the bottom (base) of the entry opening in FIG. 1 of JP H06-017960 Y2). Furthermore, the third attachment hole is also located on the pawl axis side (downward in FIG. 1 of JP H06-017960 Y2) of the entry opening in the second direction.

To mount this vehicle door lock apparatus on the vehicle frame, the base plate is fixed to the interior surface of the rear end panel of a door that is openable and closeable with respect to the vehicle frame. Specifically, first to third fasteners are inserted through holes in the rear end panel of the door and fastened to (in) the first to third attachment holes, respectively. In this way, the base plate is fixed such that the base plate contacts the interior rear side of the door.

In the vehicle door lock apparatus disclosed in FIG. 2 of Japanese Patent No. 5930273 B2 (hereinafter “JP 5930273 B2”), only a first attachment hole and a second attachment hole are formed in a base plate, i.e. there is no third attachment hole. The first attachment hole is located on the opposite side (leftward in FIG. 2 of JP 5930273 B2) of the entrance of the entry opening (inlet) with respect to the bottom (base) of the entry opening in a first (left-right) direction. Furthermore, the first attachment hole is located on the fork axis side (upward in FIG. 2 of JP 5930273 B2) of the entry opening in a second (up-down) direction that is perpendicular to the first direction. On the other hand, the second attachment hole is located closer to the entrance of the entry opening (rightward in FIG. 2 of JP 5930273 B2) than the fork axis and a pawl axis in the first direction. Furthermore, the second attachment hole is located on the pawl axis side (downward in FIG. 2 of JP 5930273 B2) of the entry opening in the second direction. As shown in FIG. 1 of JP 5930273 B2, to mount this the vehicle door lock apparatus on the vehicle frame, first and second fasteners are inserted through holes in the rear end panel of the door and are respectively fastened to (in) the first and second attachment holes, whereby the base plate is fixed such that the base plate contacts (abuts) the interior surface of the rear side of the door.

However, the design of the vehicle door lock apparatus of JP H06-017960 Y2 is problematic in that the third attachment hole is disposed on the opposite side of the entrance of the entry opening (i.e. leftward) with respect to the bottom (base) of the entry opening in the first direction. Therefore, when a door seal (weatherstrip or seal line) for sealing the space between the vehicle frame and the door (i.e. when the door is closed) is adhered to the door, the door seal must go around (circumvent) not only the entry opening but also the third attachment hole (i.e. to suitably perform the sealing function, the door seal must extend between the vehicle exterior on the one side and the entry opening and third attachment hole on the other side). Consequently, if such a vehicle door lock apparatus is used, it is difficult to design the door such that it has a reduced thickness in the first (left-right) direction due to the placement of the third attachment hole leftward of the bottom (base) of the entrance opening. Moreover, when the third fastener is engaged in the third attachment hole, it is necessary to carefully perform the fastening work to avoid pinching (biting) the door seal with the third fastener (which would impair the weatherproofing properties of the door seal), thereby complicating the manufacturing work.

The vehicle door lock apparatus of JP 5930273 B2 could theoretically permit the door to be designed thinner in the first (left-right) direction, because it does not have a third attachment hole. However, in such a vehicle door lock apparatus, because only the first and second (i.e. only two) fasteners are fastened to (in) the first and second attachment holes to fix the base plate to the rear end panel of the door, it is difficult to ensure a secure (rigid, durable) fastening of the base plate to the door.

### SUMMARY

In view of these circumstances, an object of the present teachings is to provide a vehicle door lock apparatus that permits a reduction in the thickness of the door and can simplify manufacturing while still ensuring that the base plate is securely fastened to the door.

In one aspect of the present teachings, a vehicle door lock apparatus is designed to be fixed (disposed) between a vehicle frame, to which a striker is fixed, and a door that is openable and closable with respect to the vehicle frame, and is capable of holding the door closed with respect to the vehicle frame. The vehicle door lock apparatus preferably includes:

a housing including a base plate that abuts and is fixed to a rear end panel of the door, the base plate having an entry opening, into which the striker can enter, formed therein;

a fork provided on the base plate so as to be pivotable about a fork axis, the fork being displaceable to a latched position, where the fork retains the striker in the entry opening, and to an unlatched position where the fork allows the striker to separate from the entry opening;

a pawl provided on the base plate so as to be pivotable about a pawl axis that is located on a side of the entry opening opposite to the fork axis such that the entry opening is interposed between the fork axis and the pawl axis, the pawl fixing or releasing the fork; and

an actuating mechanism provided in the housing and capable of acting on the pawl and causing the pawl to release the fork; wherein:

the base plate has a first attachment hole, in which a first fastener inserted through the rear end panel is fastened, a second attachment hole, in which a second fastener inserted through the rear end panel is fastened, and a third attachment hole, in which a third fastener inserted through the rear end panel is fastened,

the entry opening extends in a first direction,

a second direction is orthogonal to the first direction and is parallel to the base plate,

the first attachment hole is located on a first side of the entry opening in the second direction, and the second and third attachment holes are located on a second side of the entry opening in the second direction, the second side being opposite of the first side in the second direction,

the fork axis is disposed on the first side of the entry opening in the second direction and the pawl axis is disposed on the second side of the entry opening in the second direction,

the first attachment hole is located closer to an entrance of the entry opening than the fork axis in the first direction,

the second attachment hole is also located closer to the entrance of the entry opening than the fork axis in the first direction, and

the third attachment hole is located between a base (bottom) of the entry opening and the fork axis in the first direction.

Other aspects and advantages of the present invention will be apparent from the embodiments disclosed in the following description and the attached drawings, the illustrations exemplified in the drawings, and the general concept or gist of the invention disclosed in the entire description and drawings.

### BRIEF DESCRIPTION OF THE DRAWINGS

FIG. 1 is a perspective view of a vehicle door lock apparatus according to a first embodiment of the present teachings.

FIG. 2 is a perspective view of the vehicle door lock apparatus according to the first embodiment.

FIG. 3 is a side view of a base plate, a latch housing, and a latch mechanism.

FIG. 4 is an exploded perspective view of the base plate, the latch housing, and the latch mechanism.

FIG. 5 is a side view of the latch housing and the latch mechanism.

FIG. 6 is a front view of the first housing and the actuating mechanism.

FIG. 7 is another front view of the first housing and the actuating mechanism.

FIG. 8 is a first schematic view for explaining the operations of an outside open lever, an inertial lever, a fork, and a pawl.

FIG. 9 is a second schematic view for explaining the operations of the outside open lever, the inertial lever, the fork, and the pawl.

FIG. 10 is a third schematic view for explaining the operations of the outside open lever, the inertial lever, the fork, and the pawl.

FIG. 11 is a fourth schematic view for explaining the operations of the outside open lever, the inertial lever, the fork, and the pawl.

FIG. 12 is a schematic perspective view showing the base plate being fixed to a door.

FIG. 13 is a schematic diagram showing the positional relationships, etc., of first to third attachment holes defined in the base plate.

### DETAILED DESCRIPTION OF PREFERRED EMBODIMENTS

An embodiment of the present teachings will be explained below with reference to the drawings.

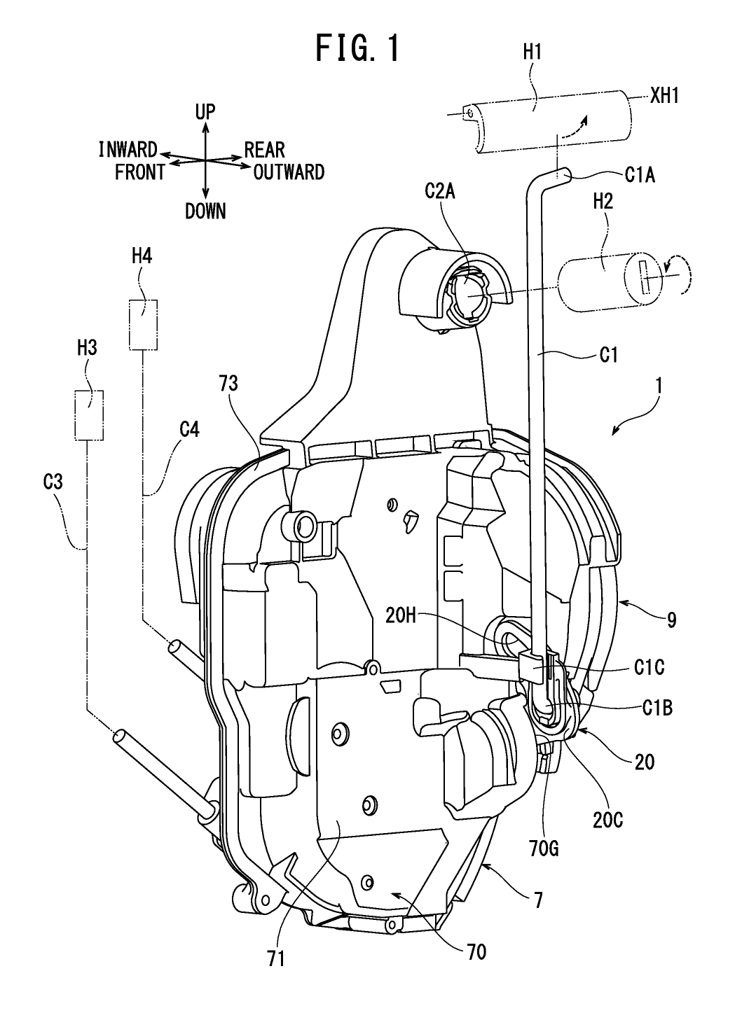

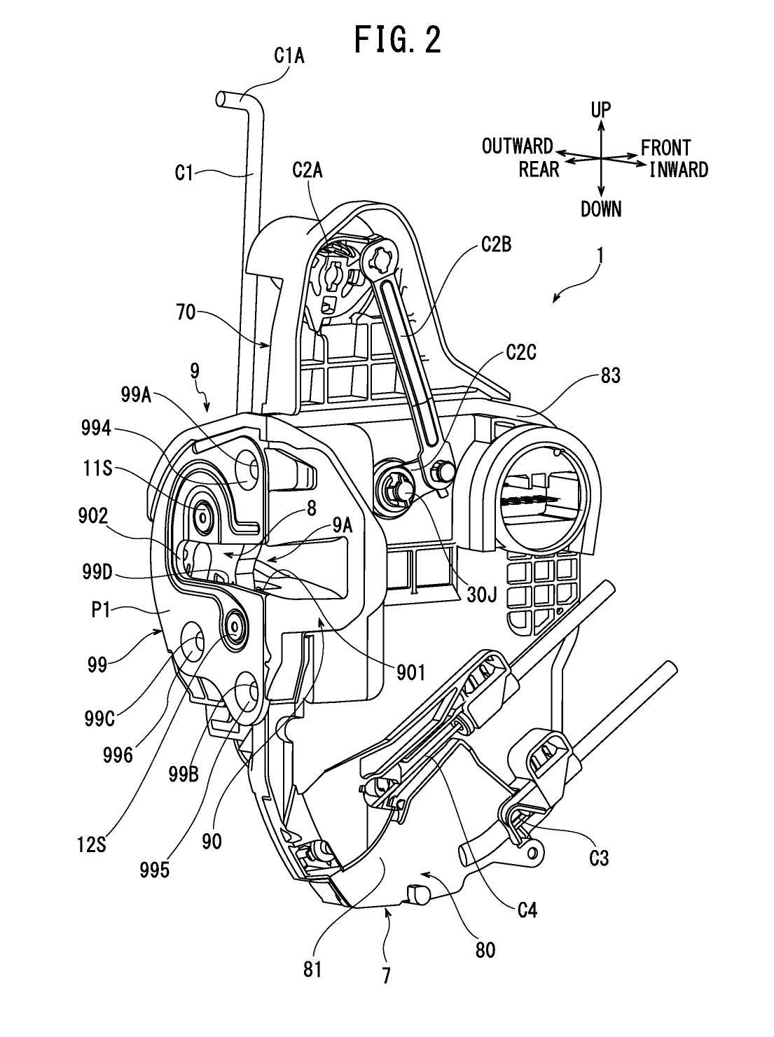

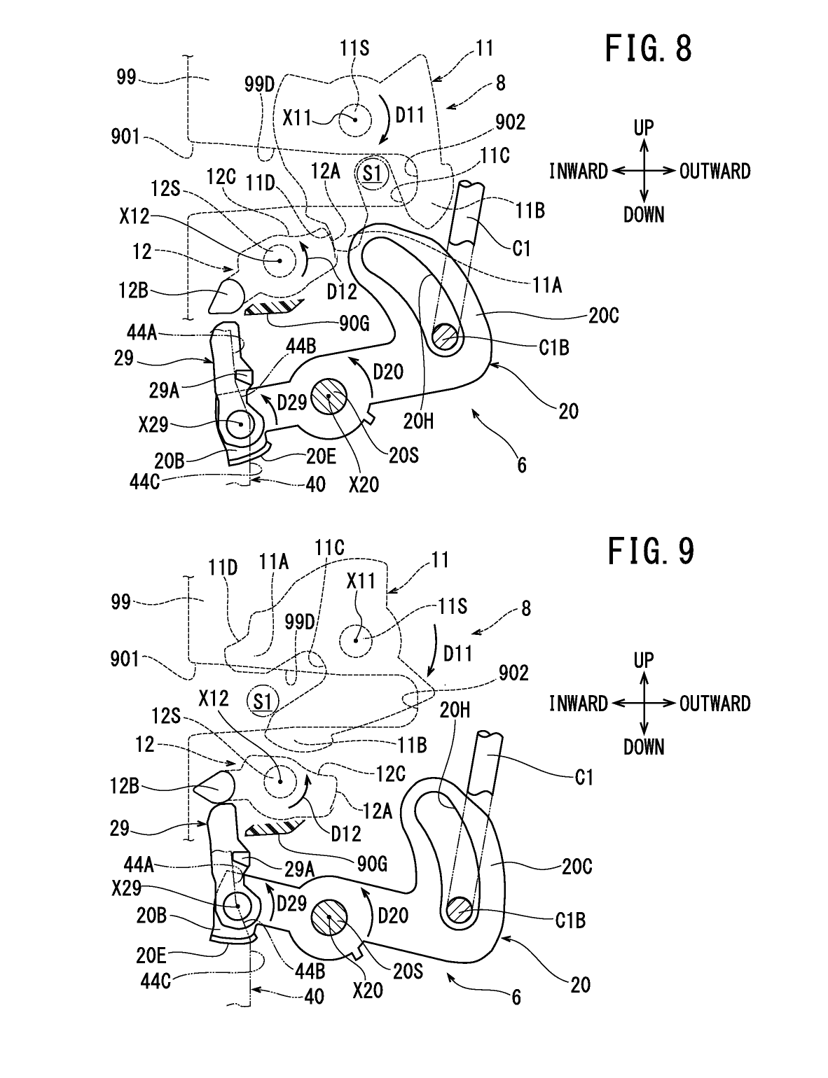

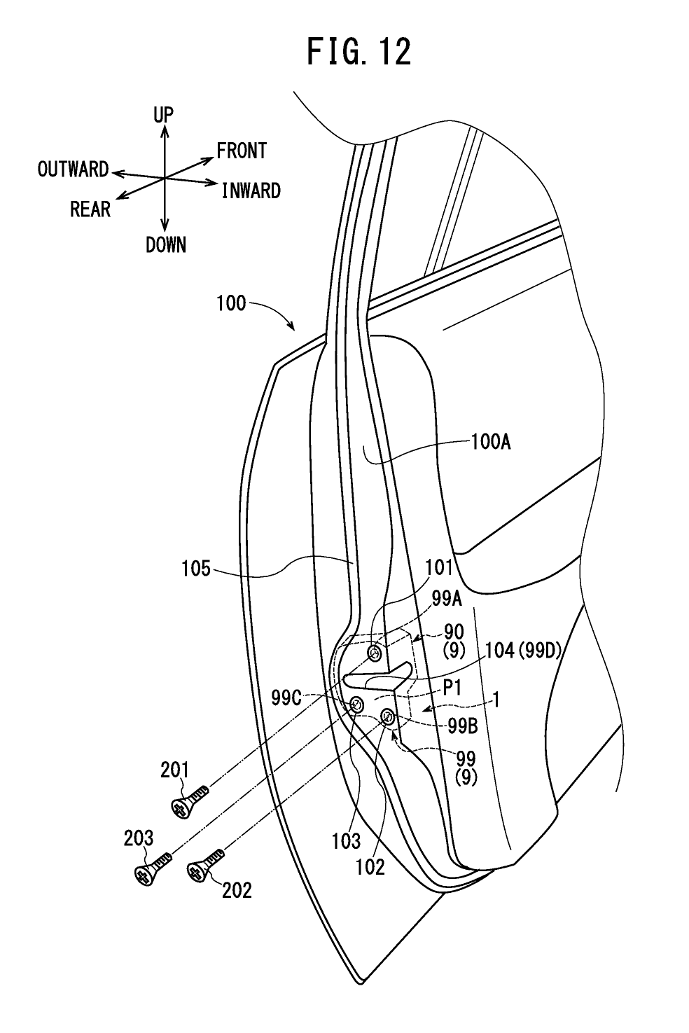

FIGS. 1 and 2 show a vehicle door lock apparatus 1 (hereinafter sometimes simply referred to as “door lock apparatus 1”) according to a representative, non-limiting first embodiment of the present teachings. As shown in FIG. 12, the door lock apparatus 1 is configured to be affixed (attached) to a door 100 that is openable and closable relative to a vehicle frame (chassis) of a vehicle, such as an automobile or a commercial vehicle, etc. By retaining (latching or holding) a striker S1 (See FIGS. 8-11) that is affixed to the vehicle frame, the door lock apparatus 1 is capable of retaining (holding) the door 100 closed with respect to the vehicle frame.

In FIGS. 1 and 2, the door lock apparatus 1 is configured to be disposed on the inside of the door 100 provided on the left side surface of the vehicle frame. It is noted that, when another door lock apparatus 1 is affixed in the interior of the door 100 provided on the right-side surface of the vehicle frame, the two door lock apparatuses 1 will be disposed in a mirror image state. In addition or in the alternative, the door lock apparatus 1 according to the present teachings can be provided in (on) a back door, or another portion of the vehicle.

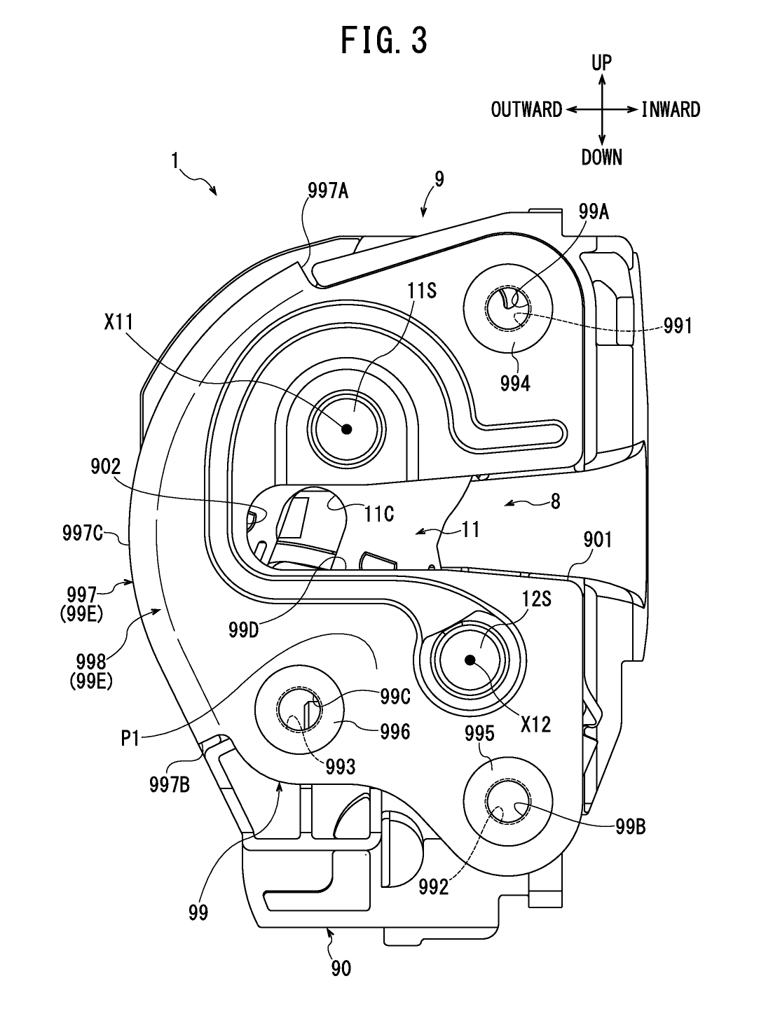

The front-rear direction and the up-down direction shown in FIGS. 1 and 2 are based on the front-rear (longitudinal) direction and the up-down (vertical or height) direction of a vehicle. The vehicle inward-outward (lateral) direction shown in FIGS. 1 and 2 is based on a person sitting in the cabin of the vehicle. The left surface side of the vehicle is set as the vehicle exterior and the opposite side is set as the vehicle interior. The front-rear direction, the up-down direction, and the vehicle inward-outward direction shown in FIG. 3 and the reference directions shown in the subsequent Figures correspond to the reference directions shown in FIGS. 1 and 2. The front-rear direction, the up-down direction, and the vehicle inward-outward direction are at least substantially orthogonal to one another. For example, the vehicle inward-outward direction is a representative, non-limiting example of the “first direction” according to the present teachings. The up-down direction is a representative, non-limiting example of the “second direction” according to the present teachings. The forward direction within the front-rear direction (i.e. a direction perpendicular to both the first and second directions) is a representative, non-limiting example of the “third direction” according to the present teachings.

As shown in FIG. 1, an exterior door handle H1 and a key cylinder H2 are disposed on the outer surface of the door 100, to which the door lock apparatus 1 is fixed (attached). The exterior door handle H1 is pivotable around a handle axis XH1 extending substantially horizontally in the front-rear direction. An interior lock knob H3 and an interior door handle H4 are disposed on the inner (interior) surface of the door 100 that is exposed to (faces) the cabin of the vehicle.

The upper end C1A of a transmission rod C1 is operably coupled to the exterior door handle H1. The door lock apparatus 1 is disposed downward of the exterior door handle H1 on the inside of the door 100. The lower end C1B of the transmission rod C1 is operably coupled to a linkage 20C of an outside open lever 20 of the door lock apparatus 1.

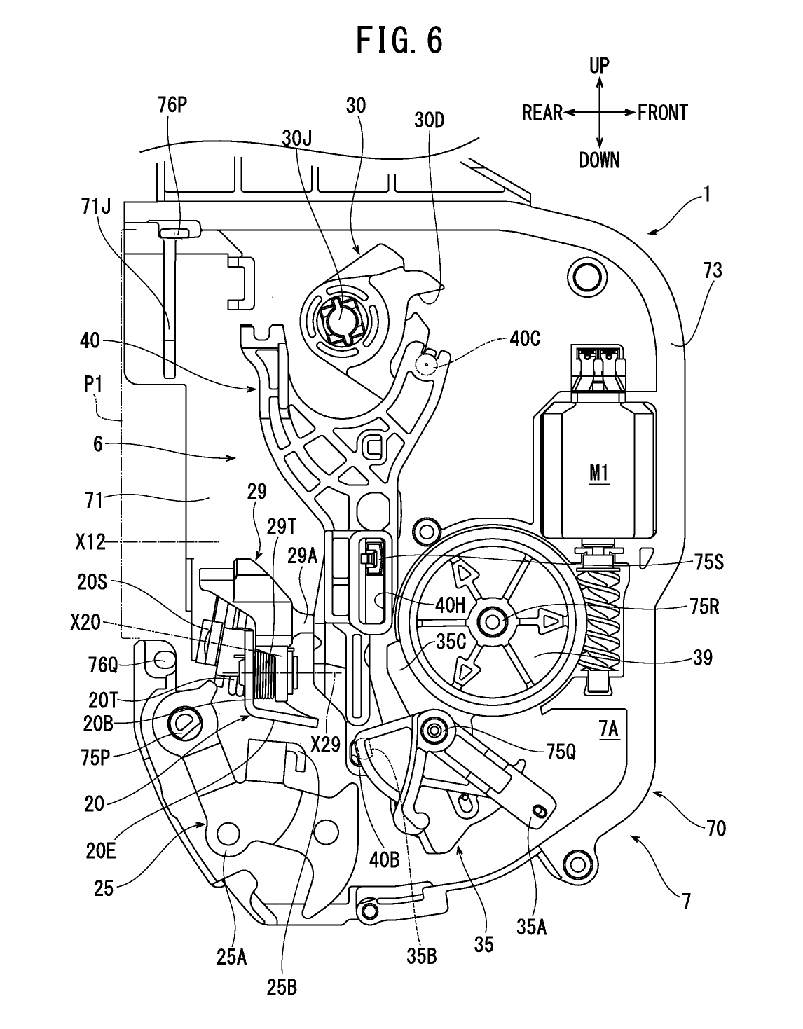

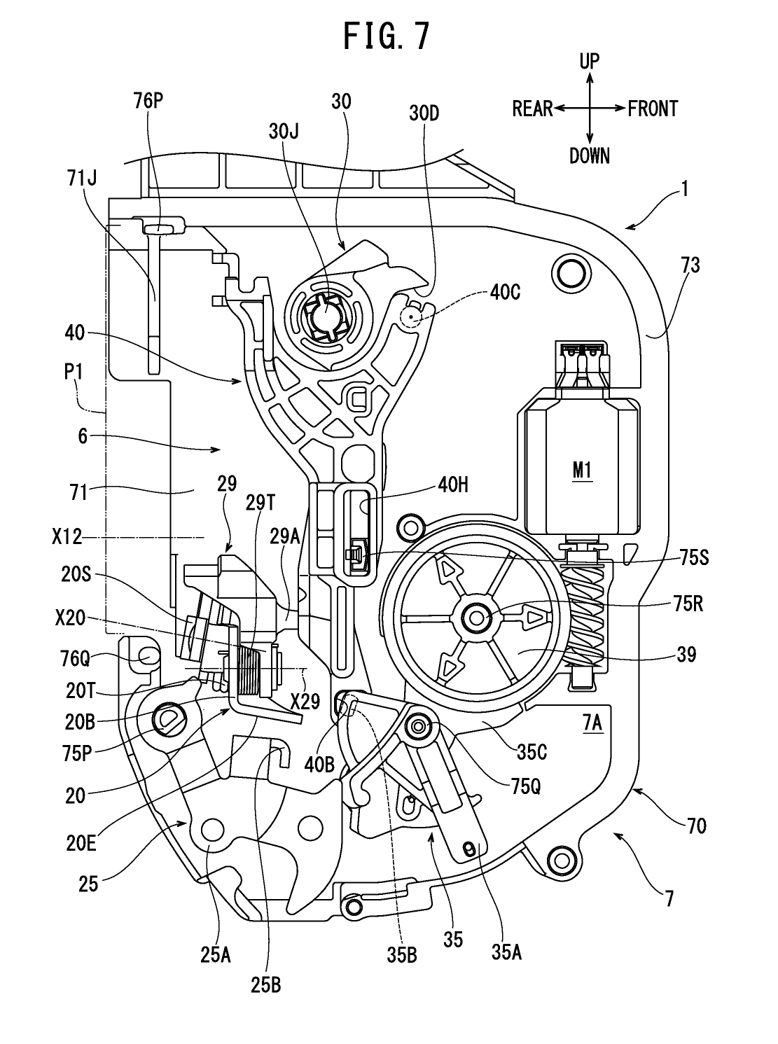

The key cylinder H2 is retained so as to be rotatable integrally with a key-cylinder retainer C2A, which is rotatably (turnably) provided at (in) the upper end portion of the door lock apparatus 1. As shown in FIG. 2, the upper end of a link rod C2B is operably coupled to the key-cylinder retainer C2A. The lower end of the link rod C2B is connected via a link lever C2C to an outside lock lever 30, which will be explained below with reference to FIGS. 6 and 7.

As shown in FIG. 1, a first end of a transmission cable C3 is connected to the interior lock knob H3. A first end of a transmission cable C4 is connected to the interior door handle H4. As shown in FIG. 2, the second end of the transmission cable C3 is drawn into the door lock apparatus 1 and connected to an inside lock lever 35, which will be explained below with reference to FIG. 6, etc. The second end of the transmission cable C4 is drawn into the door lock apparatus 1 and connected to an inside open lever 25, which will also be explained below with reference to FIGS. 6 and 7.

The door lock apparatus 1 includes a latch housing 9, as shown in FIGS. 1 to 5, and an actuating housing 7, as shown in FIGS. 1, 2, 6, and 7. As shown in FIGS. 1 and 2, the actuating housing 7 is assembled onto (joined to) the latch housing 9.

The actuating housing 7 includes a first housing 70 shown in FIG. 1 and a second housing 80 shown in FIG. 2. The first and second housings 70 and 80 are made of resin. As shown in FIGS. 1, 6 and 7, the first housing 70 includes a first peripheral edge section 73 surrounding a first base wall 71. As shown in FIG. 2, the second housing 80 includes a second peripheral edge section 83 surrounding a second base wall 81. The second housing 80 is assembled onto (joined to) the first housing 70 by disposing the first base wall 71 opposite to the second base wall 81 and welding the first peripheral edge section 73 to the second peripheral edge section 83, whereby a housing chamber 7A shown in FIGS. 6 and 7 is formed in the interior of the actuating housing 7. An actuating mechanism 6 is housed in the housing chamber 7A.

As shown in FIGS. 3 to 5, the latch housing 9 includes a third housing 90 made of resin, as well as a base plate 99 and a back plate 98, which are each made from steel plate. A fork pivot shaft 11S and a pawl pivot shaft 12S are inserted through the third housing 90. The base plate 99 is disposed behind the third housing 90. The back plate 98 is disposed in front of the third housing 90. The rear end portions of the fork pivot shaft 11S and the pawl pivot shaft 12S are respectively crimped and thereby affixed to the base plate 99. The front end portions of the fork pivot shaft 11S and the pawl pivot shaft 12S are respectively crimped and thereby affixed to the back plate 98, whereby a latch chamber 9A is formed in the interior of the latch housing 9. A latch mechanism 8 is housed in the latch chamber 9A.

As shown in FIGS. 6 and 7, first and second supports 76P and 76Q are formed in (on) the first housing 70. The first support 76P projects from the first base wall 71 near a rear and upper end portion in the first peripheral edge section 73 of the first housing 70. The second support 76Q projects from the first base wall 71 near a rear and lower end portion in the first peripheral edge section 73 of the first housing 70. The first and second supports 76P and 76Q each extend toward the second base wall 81 of the second housing 80.

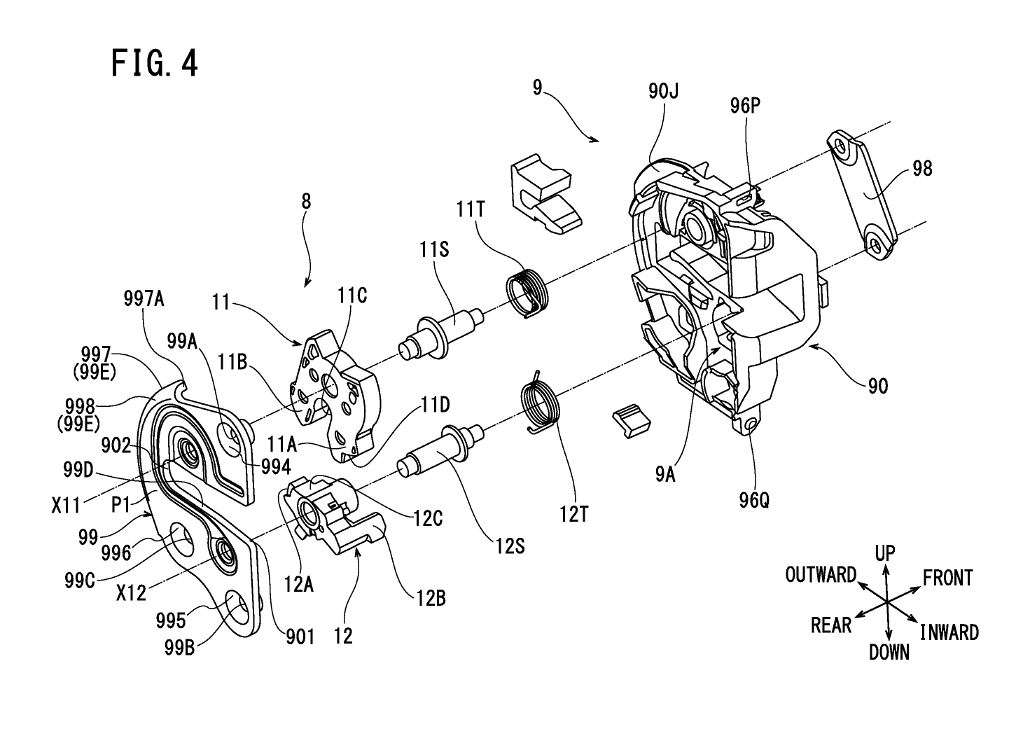

As shown in FIG. 4, first and second insertion-through holes 96P and 96Q are formed in the third housing 90. The first insertion-through hole 96P penetrates through the upper end of the third housing 90 in the vehicle inward-outward direction. The second insert-through hole 96Q penetrates through the lower end of the third housing 90 in the vehicle inward-outward direction. Although not shown in the figures, two slip-off preventing parts, which respectively align with the distal end of the first support 76P and the distal end of the second support 76Q of the first housing 70, are formed as recesses (holes) in the second housing 80.

Before the second housing 80 is assembled onto the first housing 70, the third housing 90 is provisionally assembled (mounted) onto the first housing 70. As shown, e.g., in FIGS. 6 and 7, the first housing 70 includes a groove-like guide 71J formed in the rear end portion of the first base wall 71. As shown in FIG. 4, a rib 90J protrudes from an upper end face of the third housing 90 towards the vehicle exterior. By moving the third housing 90 towards to the first housing 70 while guiding the rib 90J into the guide 71J during the assembly, the third housing 90 can be provisionally assembled with (mounted on) the first housing 70 in the proper position (orientation). As a result, an intermediate segment of the first support 76P of the first housing 70 is inserted through the first insertion-through hole 96P of the third housing 90. Similarly, an intermediate segment of the second support 76Q of the first housing 70 is inserted through the second insertion-through hole 96Q of the third housing 90.

Subsequently, when the second housing 80 is assembled (mounted) onto the first housing 70, the distal end of the first support 76P and the distal end of the second support 76Q of the first housing 70 are respectively fit into each of the slip-off preventing parts of the second housing 80. The first peripheral edge section 73 of the first housing 70 and the second peripheral edge section 83 of the second housing 80 are welded together, whereby the third housing 90 is joined to the first housing 70 and the second housing 80.

As shown in FIGS. 3 and 4, the base plate 99 of the latch housing 9 has a fixing surface P1, a first attachment hole 99A, a second attachment hole 99B, a third attachment hole 99C, an entry opening 99D, and a peripheral edge section 99E. The fixing surface P1 is formed on the surface that faces rearward of the base plate 99. Although the surface facing rearward of the base plate 99 is uneven overall, the fixing surface P1 is a flat surface designed to contact (abut) the interior rear surface of the door 100.

A first thread groove 991 is formed in the first attachment hole 99A, a second thread groove 992 is formed in the second attachment hole 99B, and a third thread groove 993 is formed in the third attachment hole 99C. First to third concave recesses 994 to 996 are respectively provided within the first to third attachment holes 99A to 99C and taper from the fixing surface P1 in the forward direction. The first attachment hole 99A is continuous with the first concave recess 994. The second attachment hole 99B is continuous with the second concave recess 995. The third attachment hole 99C is continuous with the third concave recess 996. It is noted that further details concerning the fixing of the base plate 99 to the door 100 and the positional relationships of the first to third attachment holes 99A to 99C in the base plate 99 are explained below.

The entry opening 99D is formed substantially in a “U” shape extending in the vehicle inward-outward direction. The entry opening 99D includes an entrance (inlet opening) 901 and a base (bottom or origin) 902. The entrance 901 is located on the side of the entry opening 99D that faces the vehicle interior. The base (bottom) 902 is located on the side of the entry opening 99D that is opposite of the entrance 901, i.e. on the vehicle exterior side of the entry opening 99D. When the door lock apparatus 1 moves in response to opening and closing of the door 100, the striker S1 fixed to the vehicle frame separates from (exits) or enters the entry opening 99D.

The peripheral edge section 99E is located along the end (edge) of the base plate 99 facing the vehicle exterior side and extends downward from an upper portion of the base plate 99. The peripheral edge section 99E includes a bent section 997 and a connecting (continuous) section 998. As shown in FIG. 4, the bent section 997 is bent to extend forward of the fixing surface P1. As shown in FIG. 3, the bent section 997 includes an upper end 997A, a lower end 997B, and an intermediate section 997C located between the upper end 997A and the lower end 997B in the up-down direction. It is noted that further details of the bent section 997 are explained below. The connecting (continuous) section 998 is located between the bent section 997 and the fixing surface P1, i.e. the connecting section 998 connects the fixing surface P1 to the bent section 997.

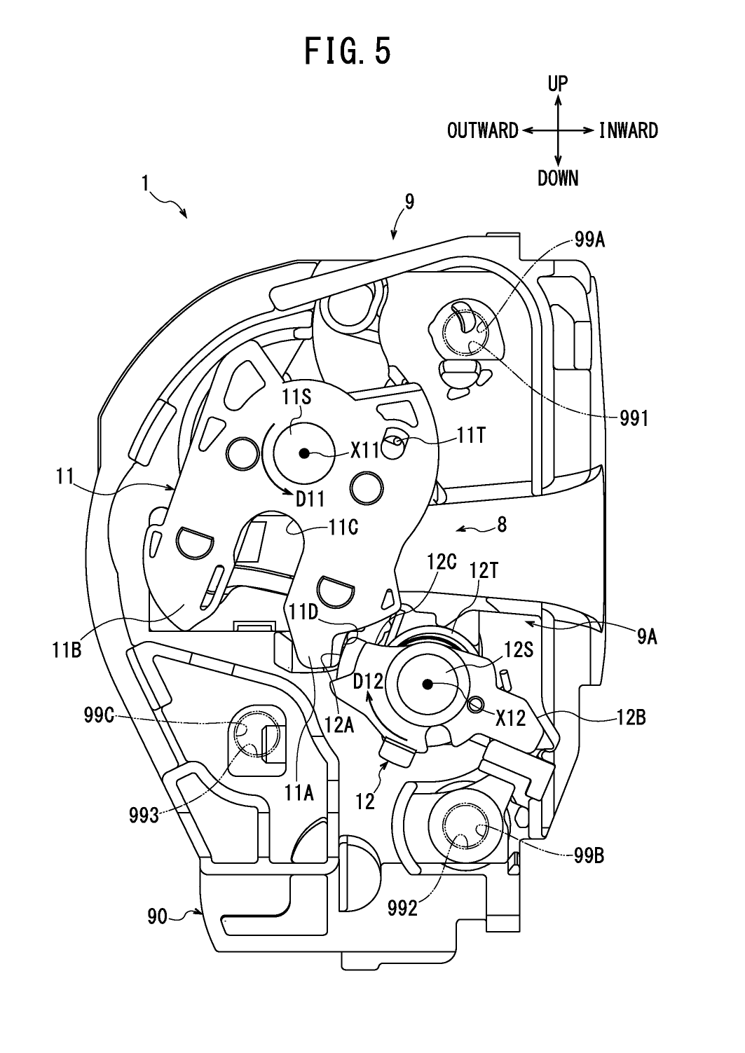

As shown in FIGS. 4 and 5, the latch mechanism 8 includes a fork 11 and a pawl 12. The fork 11 is pivotably supported by a fork pivot shaft 11S, which is disposed above the entry opening 99D. The fork pivot shaft 11S defines a fork axis X11 that is at least substantially orthogonal to the fixing surface P1. A torsion coil spring 11T is attached to the fork pivot shaft 11S. The pawl 12 is pivotably supported by a pawl pivot shaft 12S, which is disposed below the entry opening 99D. The pawl pivot shaft 12S defines a pawl axis X12 that is at least substantially orthogonal to the fixing surface P1. Since the pawl pivot shaft 12S is located below the entry opening 99D, the pawl axis X12 is located below the entry opening 99D. That is, as shown in FIG. 3, the fork axis X11 and the pawl axis X12 are located on opposite sides (i.e. the upper side and the lower side, respectively) of the entry opening 99D in the up-down direction. As shown in FIG. 4, the fork axis X11 and the pawl axis X12 are parallel. A torsion coil spring 12T is attached to the pawl pivot shaft 12S.

As shown in FIG. 5, the fork 11 is urged (biased) by the torsion coil spring 11T so as to pivot about the fork axis X11 in the D11 direction. The portion of the fork 11 that is located closest to the entry opening 99D has an inner convex segment 11A and an outer convex segment 11B. The striker S1, which is shown in FIGS. 8, 10, and 11 as having entered into the entry opening 99D, fits in a cutout 11C formed between the inner convex segment 11A and the outer convex segment 11B. Consequently, the fork 11 retains the striker S1 at the base (bottom) 902 of the entry opening 99D. As shown in FIG. 5, a latch surface 11D configured to come into contact with a stopper surface 12A, which will be explained below, is formed at (on) the distal end of the inner convex segment 11A that faces the pawl 12.

The pawl 12 is urged (biased) by the torsion coil spring 12T so as to pivot about the pawl axis X12 in the D12 direction. Consequently, the pawl 12 holds the posture (orientation) shown in FIGS. 5, 8, 10, and 11.

As shown in FIG. 5, a stopper surface 12A is formed in (on) a portion of the pawl 12 that is directed towards the base (bottom) 902 of the entry opening 99D. The stopper surface 12A is formed so as to face the latch surface 11D. An arc forming the stopper surface 12A is cut on the side that faces the fork 11. A sliding surface 12C that extends towards the pawl pivot shaft 12S is formed starting from the part (location) where the arc is cut. A contacted portion 12B is formed on the pawl 12 on the side that is opposite of the stopper surface 12A across the pawl pivot shaft 12S. As shown in FIG. 4, the contacted portion 12B projects forward and has a columnar shape. Consequently, the front end of the contacted portion 12B projects frontward from the latch chamber 9A through the third housing 90 and enters the housing chamber 7A.

As shown in FIG. 8, when the fork 11 retains (holds) the striker S1 at (on) the base (bottom) 902 of the entry opening 99D, the stopper surface 12A comes into contact with the latch surface 11D of the inner convex segment 11A, whereby the pawl 12 prevents the fork 11 from pivoting in the direction D11. The position of the fork 11 shown in FIGS. 5, 8, 10, and 11 is the latched position that holds the striker S1 in the entry opening 99D.

As shown in FIG. 9, when an inertial lever 29, which will be explained below, comes into contact with the contacted portion 12B of the pawl 12 and pushes the contacted portion 12B up, the pawl 12 pivots about the pawl axis X12 in the direction opposite of the direction D12 by overcoming the urging force of the torsion coil spring 12T. At this time, since the stopper surface 12A separates from the latch surface 11D, the pawl 12 no longer blocks the pivoting movement of the fork 11. Therefore, the fork 11 pivots about the fork axis X11 in the direction D11 due to the urging force of the torsion coil spring 11T so as to displace to the unlatched position, where the striker S1 is permitted (released) to move out of (exit) the entry opening 99D.

Conversely, when the striker S1 enters the entry opening 99D, the striker S1 pushes against the outer convex segment 11B, thereby causing the fork 11 to pivot in the direction opposite of the direction D11 and the pawl 12 to return from the unlatched position shown in FIG. 9 to the latched position shown in FIG. 8, etc. At this time, the distal end of the outer convex segment 11B and then the distal end of the inner convex segment 11A sequentially come into slide-contact with the sliding surface 12C. When the inner convex segment 11A separates from the sliding surface 12C, the pawl 12 pivots in the direction D12 and returns to the original posture. Therefore, the stopper surface 12A comes into contact with the latch surface 11D and fixes the pivoting movement of the fork 11 in the latched position. As a result, the latch mechanism 8 holds the door 100 closed with respect to the vehicle frame.

As shown in FIGS. 6 to 11, the actuating mechanism 6 includes the outside open lever 20, the inside open lever 25, the inertial lever 29, the outside lock lever 30, the inside lock lever 35, a linearly moving lock lever 40, an electric motor M1, and a worm wheel 39.

As shown in FIGS. 6 and 7, the first housing 70 includes an outside open lever pivot shaft 20S that projects rearward at (from) a rear and lower portion of the first base wall 71. The outside open lever pivot shaft 20S defines a second axis X20. Although the latch housing 9 is not shown in FIGS. 6 and 7, the positions of the fixing surface P1 and the pawl axis X12 are shown relative to the actuating mechanism 6 by broken (imaginary) lines. The second axis X20 is inclined upward in the rearward direction and is inclined with respect to the pawl axis X12, which is at least substantially orthogonal to the fixing surface P1.

A first shaft 75P is formed in (on) a rear and lower part of the first base wall 71 of the first housing 70. A second shaft 75Q is formed in (on) a part of the first base wall 71 that is farther frontward than the first shaft 75P. A third shaft 75R and a fourth shaft 75S are formed in (on) a part located substantially in the center of the first base wall 71. The first shaft 75P, the second shaft 75Q, the third shaft 75R, and the fourth shaft 75S respectively extend toward the second base wall 81 of the second housing 80.

The outside open lever 20 is pivotably supported by the outside open lever pivot shaft 20S. A torsion coil spring 20T is attached to the outside open lever pivot shaft 20S. As shown in FIGS. 8 to 11, the outside open lever 20 is urged (biased) by the torsion coil spring 20T so as to pivot about the second axis X20 in the direction D20.

As shown, e.g., in FIGS. 1 and 8, a first end of the outside open lever 20, which is located on the vehicle outward side of the outside open lever 20, projects outward of the actuating housing 7. The linkage (coupling part) 20C is formed at the first end. An arcuate elongated hole 20H penetrates through the linkage 20C; the center of an imaginary circle, along which the arc extends, is located on the second axis X20. The lower end C1B of the transmission rod C1 is bent rearward and coupled to the linkage 20C by being inserted into the elongated hole 20H with a resin clip C1C (shown in FIG. 1) securing it. The lower end C1B of the transmission rod C1 pushes the linkage 20C downward in response to an opening operation being performed on the exterior door handle H1, whereby the linkage 20C is displaced such that it traces an arcuate trajectory having its center on (at) the second axis X20.

As shown in FIG. 1, a movement guide (displacement guide) 70G is formed in the first base wall 71 of the first housing 70. The movement guide 70G is formed in a part of the first base wall 71 that is located on the vehicle outward side with respect to the outside open lever pivot shaft 20S and has an arcuate slit shape. The center of an imaginary circle, along which the arcuate slit extends, is located on (at) the second axis X20. The movement guide 70G surrounds a portion of the outside open lever 20 that is adjacent to the linkage 20C and guides the pivoting movement of the outside open lever 20 about the second axis X20.

As shown in FIGS. 6 and 7, the inertial lever 29 is supported by the other end 20B of the outside open lever 20 so as to be pivotable about a first axis X29 extending in the front-rear direction. A torsion coil spring 29T urges (biases) the inertial lever 29 so as to pivot about the first axis X29 in the direction D29 as shown in FIG. 8. As shown in FIGS. 6 and 7, the first axis X29 is at least substantially parallel to the pawl axis X12. Consequently, the second axis X20 is inclined with respect to the first axis X29.

When the exterior door handle H1 (see FIG. 1) is operated (e.g., manually pulled) to open the door and the transmission rod C1 has moved downward as shown in FIG. 9, the linkage 20C of the outside open lever 20 is pushed down too. The outside open lever 20 pivots in the direction opposite of the direction D20, thereby raising the inertial lever 29. More specifically, the inertial lever 29 rises while being inclined upward and frontward according to the inclination of the second axis X20 with respect to the pawl axis X12. At this time, the upper end surface of the inertial lever 29 is maintained in the state of being at least substantially parallel to the lower end surface of the pawl 12.

As shown in FIGS. 6 and 7, the inside open lever 25 is pivotably supported by the first shaft 75P. The second end of the transmission cable C4 (see FIGS. 1 and 2) is operably coupled to one end 25A of the inside open lever 25 that is spaced downward from the first shaft 75P. That is, the inside open lever 25 is operably coupled to the interior door handle H4 via the transmission cable C4.

As shown in FIGS. 6 and 7, an operating part 25B is formed on a part above the one end 25A of the inside open lever 25. The inside open lever 25 pivots counterclockwise when the interior door handle H4 is operated (e.g., manually pulled) to open the door. Consequently, the operating part 25B pushes the other end 20B of the outside open lever 20 up and raises the inertial lever 29.

A lower surface 20E on the other end 20B of the outside open lever 20 extends at least substantially parallel to the second axis X20 and is inclined slightly downward. For this reason, when the operating part 25B of the inside open lever 25 comes into contact with the lower surface 20E, the force imparted by the operating part 25B to push up the other end 20B of the outside open lever 20 is reliably transmitted to the outside open lever 20.

The outside lock lever 30 is pivotably supported by a lock lever pivot shaft (not shown in the figures) that projects from an upper part of the first base wall 71. An engaging concave segment 30D is formed as a recess in the outside lock lever 30 and bends in the radial inward direction. The outside lock lever 30 includes a coupling shaft 30J that projects toward the vehicle interior. As shown in FIG. 2, the coupling shaft 30J projects outward of the second housing 80. The link lever C2C is fixed to the distal end of the coupling shaft 30J so as to be integrally rotatable therewith.

Referring to FIG. 6, the outside lock lever 30 pivots counterclockwise in response to a locking operation being performed on the key cylinder H2. On the other hand, the outside lock lever 30 pivots clockwise in response to an unlocking operation being performed on the key cylinder H2.

The inside lock lever 35 is pivotably supported by the second shaft 75Q. The second end of the transmission cable C3 (shown in FIGS. 1 and 2) is coupled to one end 35A of the inside lock lever 35. That is, the inside lock lever 35 is operably coupled to the interior door lock knob H3 via the transmission cable C3. The inside lock lever 35 pivots from the position shown in FIG. 6 to the position shown in FIG. 7 in response to a locking operation being performed on the interior door lock knob H3. The inside lock lever 35 pivots from the position shown in FIG. 7 to the position shown in FIG. 6 in response to an unlocking operation being performed on the interior door lock knob H3.

A cam 35C is formed in an upper part of the inside lock lever 35. An operating part 35B projects toward the vehicle exterior from the surface of the inside lock lever 35 that faces the vehicle exterior.

The worm wheel 39 is rotatably (turnably) supported by the third shaft 75R. A cam section (not shown in the figures) configured to engage with the cam 35C of the inside lock lever 35 is formed on the surface of the worm wheel 39 that faces the vehicle exterior. When the electric motor M1 is actuated in response to a locking operation or an unlocking operation requested by a remote control key or the like, the worm wheel 39 is driven by the electric motor M1 to rotate and thereby turns (pivots) clockwise or counterclockwise. Due to the engagement of the cam section and the cam 35C, the worm wheel 39 causes the inside lock lever 35 to pivot between the position shown in FIG. 6 and the position shown in FIG. 7.

The fourth shaft 75S is inserted through an elongated hole 40H that extends in the up-down direction, whereby the linearly moving lock lever 40 is supported by the fourth shaft 75S so as to be linearly movable. The fourth shaft 75S has a substantial “C” shaped cross-section. The linearly moving lock lever 40 has a substantial “Y” shape that forks above the elongated hole 40H. The linearly moving lock lever 40 is capable of linearly moving in the up-down direction.

A concave recess 40B is formed in the lower end portion of the linearly moving lock lever 40. The operating part 35B of the inside lock lever 35 engages in the concave recess 40B. An engaging convex part 40C projects toward the vehicle exterior at the distal end of a part of the linearly moving lock lever 40 that branches forward and upward. The engaging convex part 40C projects into the engaging concave segment 30D of the outside lock lever 30.

When the inside lock lever 35 pivots from the position shown in FIG. 6 to the position shown in FIG. 7 in response to a locking operation being performed on the interior lock knob H3 or a locking operation requested by the remote control key or the like, the displacement of the inside lock lever 35 is transmitted to the linearly moving lock lever 40 via the concave recess 40B and the operating part 35B. The linearly moving lock lever 40 is pushed up from the position shown in FIG. 6 to the position shown in FIG. 7. When the inside lock lever 35 pivots from the position shown in FIG. 7 to the position shown in FIG. 6 in response to an unlocking operation being performed on the interior door lock knob H3 or an unlocking operation on requested by the remote control key or the like, the linearly moving lock lever 40 is pulled down from the position shown in FIG. 7 to the position shown in FIG. 6.

As shown in FIGS. 8 to 11, a first surface 44A, a second surface 44B, and a third surface 44C are formed on the linearly moving lock lever 40 between the elongated hole 40H and the concave recess 40B. The first surface 44A, the second surface 44B, and the third surface 44C are formed on the surface of the linearly moving lock lever 40 that faces the vehicle exterior. The first surface 44A and the third surface 44C are both flat surfaces that extend in the up-down direction. The first surface 44A is displaced (shifted) more towards the vehicle interior than the third surface 44C. The second surface 44B is an inclined surface that connects the lower end of the first surface 44A with the upper end of the third surface 44C.

An inertial lever guide surface 90G is formed on the third housing 90 on the side of the housing chamber 7A. The inertial lever guide surface 90G is a downward flat surface located farther towards the vehicle exterior than the contacted portion 12B of the pawl 12. The inertial lever guide surface 90G extends toward the vehicle exterior so as to separate (be spaced) from the contacted portion 12B. As shown in FIG. 8, when the outside open lever 20 has not yet been pivoted, the inertial lever guide surface 90G is located between the lower end of the contacted portion 12B and the upper end of the inertial lever 29 in the up-down direction.

When the linearly moving lock lever 40 is located at the position shown in FIGS. 6, 8, and 9, the projection 29A of the inertial lever 29 comes into contact with the first surface 44A of the linearly moving lock lever 40, whereby the inertial lever 29 is retained in an upward position. In the state shown in FIG. 9, if the inertial lever 29 rises, the inertial lever 29 comes into contact with the contacted portion 12B and causes the pawl 12 to open the fork 11.

When the linearly moving lock lever 40 is displaced to the position shown in FIGS. 7, 10, and 11, the projection 29A of the inertial lever 29 comes into slide-contact with the second surface 44B of the linearly moving lock lever 40 and then comes into contact with the third surface 44C, whereby the inertial lever 29 is held inclined toward the vehicle exterior. In the state shown in FIG. 11, if the inertial lever 29 rises, since the inertial lever 29 comes into contact with the inertial lever guide surface 90G, the inertial lever 29 separates from the contacted portion 12B. Therefore, the pawl 12 continues to fix (retain) the fork 11.

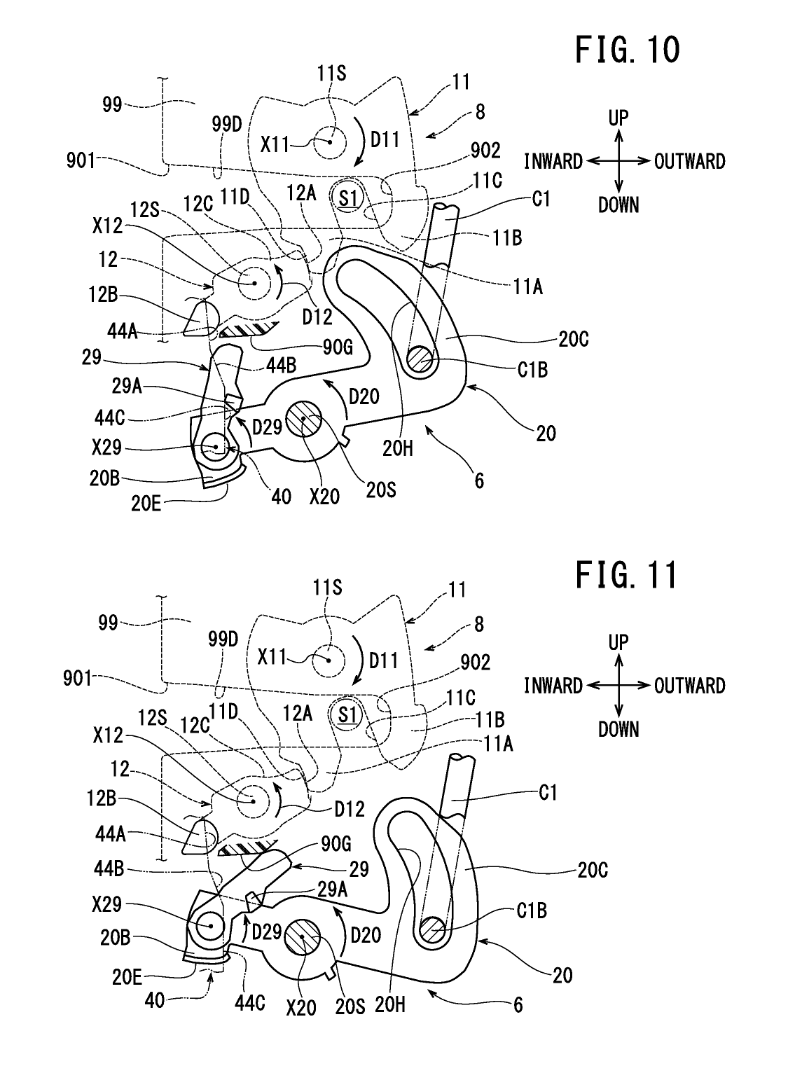

The position of the inertial lever 29 shown in FIGS. 8 and 9 is an unlock position where the inertial lever 29 is capable of acting on the pawl 12. The position of the inertial lever 29 shown in FIGS. 10 and 11 is a lock position where the inertial lever 29 is incapable of acting on the pawl 12.

The position of the linearly moving lock lever 40 shown in FIGS. 7, 10, and 11 is a locked position. In the locked position, the third surface 44C comes into contact with the projection 29A and the linearly moving lock lever 40 retains the inertial lever 29 in the lock position. The position of the linearly moving lock lever 40 shown in FIGS. 6, 8, and 9 is an unlocked position. In the unlocked position, the third surface 44C separates (is spaced) from the projection 29A and the linearly moving lock lever 40 does not hold the inertial lever 29 in the lock position shown in FIGS. 10 and 11. The inertial lever 29 brings the projection 29A into contact with the first surface 44A due to the urging force of the torsion coil spring 29T. When an impact (shock or impulse) acts on the inertial lever 29, the inertial lever 29 causes the projection 29A to separate from the first surface 44A and is displaced to the lock position.

In the unlocked position, the linearly moving lock lever 40 causes the inertial lever 29 to stand upright and enables the fork 11 located in the latched position shown in FIG. 8 to be displaced to the unlatched position shown in FIG. 9. In the locked position, the linearly moving lock lever 40 inclines the inertial lever 29 and disables the fork 11 located in the latched position to be displaced to the unlatched position.

The door lock apparatus 1 having such a configuration is fixed to the door 100 as explained below. As shown in FIG. 12, a first through-hole 101, a second through-hole 102, a third through-hole 103, and a cutout 104 are formed in (through) a rear end panel 100A of the door 100. When the door lock apparatus 1 is disposed on the interior surface of the rear end panel 100A of the door 100, the fixing surface P1 of the base plate 99 contacts (abuts) the rear end panel 100A of the door 100. At this time, the first attachment hole 99A and the first through-hole 101 are aligned. Similarly, the second attachment hole 99B and the second through-hole 102 are aligned and the third attachment hole 99C and the third through-hole 103 are also aligned. Further, the entry opening 99D and the cutout 104 are aligned. In this state, the first attachment screw 201 is inserted through the first through-hole 101 from the rear of the door 100 and fastened to (in) the first attachment hole 99A. Similarly, the second attachment screw 202 is inserted through the second through-hole 102 and is fastened to (in) the second attachment hole 99B. Finally, the third attachment screw 203 is inserted through the third through-hole 103 and is fastened to (in) the third attachment hole 99C. In this way, the base plate 99 is fixed to the interior side of the rear end panel 100A, whereby the door lock apparatus 1 is fixed to the door 100.

A door seal (weatherstrip) 105 made of synthetic rubber is adhered to the exterior surface of the rear end panel 100A. The door seal 105 seals the space (gap) between the vehicle frame and the rear end panel 100A of the door 100 in the front-rear direction to thereby prevent (block) rain water and the like from intruding into the vehicle interior. In the area around the third through-hole 103 and the cutout 104, i.e. where the third attachment hole 99C and the entry opening 99D are formed in the base plate 99, the door seal 105 is curved (bulged) toward the vehicle outward side so as to go around (circumvent) the third through-hole 103, the cutout 104, the third attachment hole 99C, and the entry opening 99D. It is noted that only the latch housing 9 of the door lock apparatus 1 is shown in FIG. 12 to facilitate the explanation. The shapes of the latch housing 9 and the base plate 99 are shown in an exaggerated manner.

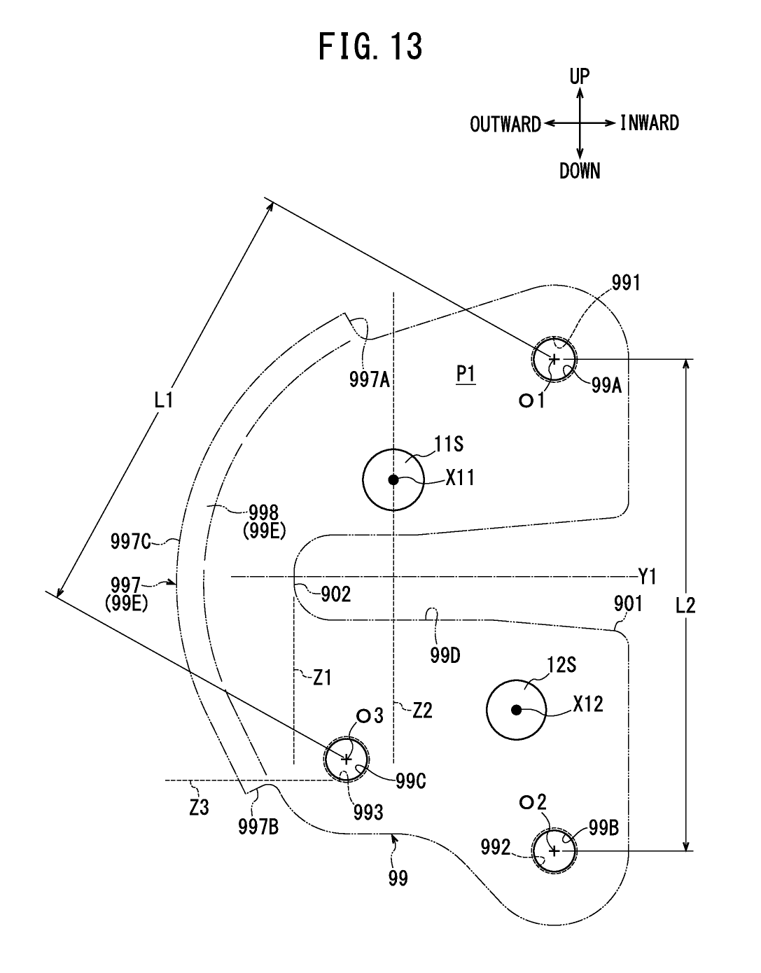

The positional relationships of the first to third attachment holes 99A to 99C and the shape of the peripheral edge section 99E of the base plate 99 will now be explained in further detail with reference to FIG. 13. A center line Y1 is shown on the base plate 99. The center line Y1 extends in parallel to the vehicle inward-outward direction and along the longitudinal direction of the entry opening 99D. The first attachment hole 99A having the first thread groove 991 is located closer to the side of the entrance 901 of the entry opening 99D than the fork axis X11 and the pawl axis X12 in the vehicle inward-outward direction. In addition, the first attachment hole 99A is located above the center line Y1 on the side of the fork axis X11. That is, the first attachment hole 99A is disposed above the entry opening 99D in the base plate 99.

The second attachment hole 99B having the second thread groove 992 is also located closer to the side of the entrance 901 of the entry opening 99D than the fork axis X11 and the pawl axis X12 in the vehicle inward-outward direction. On the other hand, the second attachment hole 99B is located below the center line Y1 on the side of the pawl axis X12. That is, the second attachment hole 99B is located below the entry opening 99D and substantially right under the first attachment hole 99A across the entry opening 99D in the base plate 99.

The third attachment hole 99C having the third thread groove 993 is located closer to the vehicle exterior side than the pawl axis X12 and more specifically, is located between the base (bottom) 902 of the entry opening 99D and the fork axis X11 in the vehicle inward-outward direction. The third attachment hole 99C is located below the center line Y1 on the side of the pawl axis X12. Further, the third attachment hole 99C is disposed at a position that is at least substantially below the striker S1 (see FIG. 8) when the striker S1 is held (latched) by the fork 11 in the entry opening 99D, i.e. when the fork 11 has been pivoted to its latched position. More specifically, the third attachment hole 99C is located below the entry opening 99D between a first extension line Z1, which extends in the up-down direction and intersects the base (bottom) 902, and a second extension line Z2, which also extends in the up-down direction (parallel to the first extension line Z1) and intersects the fork axis X11. Furthermore, the third attachment hole 99C is located above the second attachment hole 99B.

As was explained above, in the up-down direction of the base plate 99, the first attachment hole 99A is located on a first (upper) side of the entry opening 99D, whereas the second and third attachment holes 99B and 99C are located on a second (opposite, lower) side of the entry opening 99D. In addition, the third attachment hole 99C is located closer to the vehicle exterior than the first and second attachment holes 99A and 99B. As shown in FIG. 5, the first attachment hole 99A having the first thread groove 991 is located closer to the outer peripheral edge of the latch housing 9 than the pivoting range of the fork 11 when the fork 11 pivots about the fork axis X11. The second attachment hole 99B having the second thread groove 992 is located closer to the outer peripheral edge of the latch housing 9 than the pivoting range of the pawl 12 when the pawl 12 pivots about the pawl axis X12. Further, the third attachment hole 99C having the third thread groove 993 is located closer to the outer peripheral edge of the latch housing 9 than both the pivoting range of the fork 11 when the fork 11 pivots about the fork axis X11 and the pivoting range of the pawl 12 when the pawl 12 pivots about the pawl axis X12. In view of this placement of the attachments holes 99A-99C, interference between the first attachment screw 201 fastened to (in) the first attachment hole 99A and the fork 11 that pivots about the fork axis X11 is prevented. Similarly, interference between the second attachment screw 202 fastened to (in) the second attachment hole 99B and the pawl 12 that pivots about the pawl axis X12 is also prevented. Moreover, interference between the third attachment screw 203 fastened to (in) the third attachment hole 99C and both the fork 11 that pivots about the fork axis X11 and the pawl 12 that pivots about the pawl axis X12 is also prevented. It is noted that the first to third attachment holes 99A to 99C and the first to third thread grooves 991 to 993 are indicated by broken (imaginary) lines in FIG. 5 to facilitate the explanation.

Further, as shown in FIG. 13, a first distance L1 between the center O1 of the first attachment hole 99A and the center O3 of the third attachment hole 99C is set to length equal to or less than a second distance L2 between the center O1 of the first attachment hole 99A and the center O2 of the second attachment hole 99B.

The bent section 997 of the peripheral edge section 99E is formed in an arcuate shape that curves toward the vehicle exterior along the portion (segment) from the upper end 997A to the intermediate section 997C and then curves toward the vehicle interior in the portion (segment) from the intermediate section 997C to the lower end 997B. Consequently, the upper end 997A and the lower end 997B of the bent section 997 are closer to the entrance 901 of the entry opening 99D than the intermediate section 997C. The lower end 997B is separated (spaced) farther away from the entry opening 99D than the third attachment hole 99C in the up-down direction. That is, the lower end 997B is located below a third extension line Z3 that extends in the vehicle inward-outward direction and intersects (extends tangentially from) the lowermost edge of the third attachment hole 99C. The upper end 997A is separated (spaced) farther away from the entry opening 99D than the fork axis X11 in the up-down direction. That is, the upper end 997A is located farther above the entry opening 99D than the fork axis X11.

### Operation and Effects

In one aspect of the above-described door lock apparatus 1, since the first to third attachment screws 201 to 203 are respectively fastened to (in) the first to third attachment holes 99A to 99C, it is possible to securely fix the base plate 99 to the rear end panel 100A of the door 100. That is, for example, as compared to an embodiment in which there is no third attachment hole (99C) in the base plate 99 and thus the base plate 99 is fixed to the rear end panel 100A of the door 100 by fastening only the first and second fasteners 201 and 202 to (in) the first and second attachment holes 99A and 99B, the above-described door lock apparatus 1 advantageously ensures a greater fixing strength of the base plate 99 to the door 100.

Further, in another aspect of the above-described door lock apparatus 1, the first attachment hole 99A is separated (spaced) farther upward from the entry opening 99D than the fork axis X11. On the other side, the second and third attachment holes 99B and 99C are separated (spaced) farther downward from the entry opening 99D than the pawl axis X12. Therefore, because the spacings between the first to third attachment holes 99A-99C increase, it is possible to advantageously increase the fixing strength of the base plate 99 to the door 100 in view of this design feature as well.

In another aspect of the above-described door lock apparatus 1, the third attachment hole 99C is located between the base (bottom) 902 of the entry opening 99D and the fork axis X11 in the vehicle inward-outward direction. That is, the third attachment hole 99C does not protrude beyond the (base) bottom 902 of the entry opening 99D towards the vehicle exterior in the vehicle inward-outward direction. Therefore, as shown in FIG. 12, even though the third attachment hole 99C is formed in the base plate 99, it is possible to reduce (minimize) the bulge (curve) of the door seal 105 towards the vehicle exterior in the area around the entry opening 99D and cutout 104. As a result, it is not necessary to design the door 100 so as to provide a wide space for the door seal 105 to bulge (curve) towards the vehicle exterior (i.e. the rear end panel 100A and thus the door 100 can be designed narrower in the vehicle inward-outward direction). Furthermore, when the third attachment screw 203 is fastened to (in) the third attachment hole 99C, the third attachment screw 203 is less likely to pinch (bite) the door seal 105. Moreover, the third attachment hole 99C is located closer to the side of the base (bottom) 902 of the entry opening 99D than the fork axis X11 in the vehicle inward-outward direction (i.e. the third attachment hole 99C is located between the first and second extension lines L1 and L2 in the vehicle inward-outward direction). Therefore, even if the position of the third attachment hole 99C is changed, fixing strength can be more easily maintained. In particular, the third attachment hole 99C is located at a position on the base plate 99 that is at least substantially directly below the striker S1 when the striker S1 is held (latched) by the fork 11 in the entry opening 99D. Therefore, according to such a door lock apparatus 1, even if an impact force that might otherwise cause the striker S1 to separate from the entry opening 99D is applied to the door 100 (when it is closed with respect to the vehicle frame) due to a vehicle side collision or the like, the base plate 99 is fixed to the door 100 with a sufficient fixing strength to endure such an impact without the door 100 opening. That is, with such a door lock apparatus 1, even if an impact such as vehicle side collision acts on the door 100, the striker S1 is less likely to separate from the entry opening 99D, thereby preventing or at least reducing the likelihood of a sudden (undesired) release (opening) of the door 100.

Therefore, in one aspect of the present teachings, the door lock apparatus 1 according to the above-described embodiment makes it possible to achieve a reduction in thickness of the door 100 in the vehicle inward-outward direction and simplify manufacturing while advantageously ensuring sufficient fixing strength of the base plate 99 to the door 100.

For example, in the above-described embodiment, the first distance L1 between the center O1 of the first attachment hole 99A and the center O3 of the third attachment hole 99C is set to the length equal to or less than the second distance L2 between the center O1 of the first attachment hole 99A and the center O2 of the second attachment hole 99B. For this reason, the door lock apparatus 1 makes possible a thickness reduction of the door 100 while still ensuring a suitable fixing strength of the base plate 99 to the door 100.

In another aspect of the above-described door lock apparatus 1, the peripheral edge section 99E is formed on the base plate 99 and includes the bent section 997 that is bent forward. The bent section 997 is curved in an arcuate shape such that the upper end 997A and the lower end 997B are closer to the entrance 901 of the entry opening 99D in the vehicle inward-outward direction than the intermediate section 997C. Further, the lower end 997B is separated (spaced) farther away from the entry opening 99D than the third attachment hole 99C. On the other side, the upper end 997A is separated (spaced) farther away from the entry opening 99D than the fork axis X11. Thus, the door lock apparatus 1 is designed such that the fixing surface P1 of the base plate 99 is reinforced by the bent section 997. In view of this design feature as well, the above-described door lock apparatus 1 makes it possible to suitably ensure sufficient fixing strength of the base plate 99 to the door 100.

Although the present invention has been described above in line with a detailed embodiment, it is needless to say that the invention is not limited to the above-described embodiment, and it may be appropriately modified in application without departing from the gist of the invention.

For example, in the above-described door lock apparatus 1, the first attachment hole 99A is located closer to the entrance 901 of the entry opening 99D than the fork axis X11 and the pawl axis X12 in the vehicle inward-outward direction. However, the door lock apparatus 1 may be modified such that the first attachment hole 99A is located closer to the (base) bottom 902 of the entry opening 99D than the pawl axis X12 as long as the first attachment hole 99A is located closer to the entrance 901 of the entry opening 99D than the fork axis X11 in the vehicle inward-outward direction. The same applies to the second attachment hole 99B.

In the door lock apparatus 1, the bent section 997 is curved in an arcuate shape so that the upper end 997A and the lower end 997B are closer to the entrance 901 of the entry opening 99D in the vehicle inward-outward direction than the intermediate section 997C. However, the bent section 997 of the door lock apparatus 1 may be modified such that the bent section 997 is bent or angled in a linear manner as long as the upper end 997A and the lower end 997B remain closer to the entrance 901 than the intermediate section 997C.

In addition, the actuating mechanism 6 may be embodied in various ways known in the art without departing from the present teachings.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved vehicle door lock apparatuses and methods for manufacturing and operating the same.

Moreover, combinations of features and steps disclosed in the above detail description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

1. A vehicle door lock apparatus that is fixedly disposed between a vehicle frame, to which a striker is fixed, and a door that is openable and closable with respect to the vehicle frame, and is capable of holding the door closed with respect to the vehicle frame, the vehicle door lock apparatus comprising:
a housing including a base plate that abuts and is fixed to a rear end panel of the door, the base plate having an entry opening, into which the striker can enter, formed therein;
a fork provided on the base plate so as to be pivotable about a fork axis, the fork being displaceable to a latched position, where the fork retains the striker in the entry opening, and to an unlatched position where the fork allows the striker to separate from the entry opening;
a pawl provided on the base plate so as to be pivotable about a pawl axis that is located on a side of the entry opening opposite to the fork axis such that the entry opening is interposed between the fork axis and the pawl axis, the pawl being configured to move so as to fix or release the fork; and
an actuating mechanism provided in the housing and being configured to act on the pawl to cause the pawl to release the fork;
wherein:
the base plate has a first attachment hole, in which a first fastener inserted through the rear end panel is fastened, a second attachment hole, in which a second fastener inserted through the rear end panel is fastened, and a third attachment hole, in which a third fastener inserted through the rear end panel is fastened,
the entry opening extends in a first direction,
a second direction is orthogonal to the first direction and is parallel to the base plate,
the first attachment hole is located on a first side of the entry opening in the second direction, and the second and third attachment holes are located on a second side of the entry opening in the second direction, the second side being opposite of the first side in the second direction,
the fork axis is disposed on the first side of the entry opening in the second direction and the pawl axis is disposed on the second side of the entry opening in the second direction,
the first attachment hole is located closer to an entrance of the entry opening than the fork axis in the first direction,
the second attachment hole is located closer to the entrance of the entry opening than the fork axis in the first direction, and
the third attachment hole is located between a base of the entry opening and the fork axis in the first direction.

2. The vehicle door lock apparatus according to claim 1, wherein:
the first attachment hole is spaced farther away from the entry opening than the fork axis in the second direction,
the second attachment hole is spaced farther away from the entry opening than the pawl axis in the second direction, and
the third attachment hole is spaced farther away from the entry opening than the pawl axis in the second direction.

3. The vehicle door lock apparatus according to claim 2, wherein a first distance between a center of the first attachment hole and a center of the third attachment hole is equal to or less than a second distance between the center of the first attachment hole and a center of the second attachment hole.

4. The vehicle door lock apparatus according to claim 3, wherein:
a peripheral edge section is located on a side of the base plate that is opposite of the entrance of the entry opening in the first direction and extends in the second direction,
the peripheral edge section includes a bent section that is bent in a third direction and extends in the second direction, and
the third direction is at least substantially orthogonal to both the first direction and the second direction.

5. The vehicle door lock apparatus according to claim 4, wherein the bent section is curved or angled such that first and second ends of the bent section in the second direction are closer, in the first direction, to the entrance of the entry opening than an intermediate section located between the first and second ends of the bent section in the second direction.

6. The vehicle door lock apparatus according to claim 5, wherein:
the first end of the bent section is spaced farther away from the entry opening than the third attachment hole in the second direction, and
the second end of the bent section is spaced farther away from the entry opening than the fork axis in the second direction.

7. The vehicle door lock apparatus according to claim 1, wherein a first distance between a center of the first attachment hole and a center of the third attachment hole is equal to or less than a second distance between the center of the first attachment hole and a center of the second attachment hole.

8. The vehicle door lock apparatus according to claim 1, wherein:
a peripheral edge section is located on a side of the base plate that is opposite of the entrance of the entry opening in the first direction and extends in the second direction,
the peripheral edge section includes a bent section that is bent in a third direction and extends in the second direction,
the third direction is at least substantially orthogonal to both the first direction and the second direction.

9. The vehicle door lock apparatus according to claim 8, wherein the bent section is curved or angled such that first and second ends of the bent section in the second direction are closer, in the first direction, to the entrance of the entry opening than an intermediate section located between the first and second ends of the bent section in the second direction.

10. The vehicle door lock apparatus according to claim 8, wherein:
the first end of the bent section is spaced farther away from the entry opening than the third attachment hole in the second direction, and
the second end of the bent section is spaced farther away from the entry opening than the fork axis in the second direction.

11. A vehicle comprising:
a vehicle frame;
a striker affixed to the vehicle frame;
a vehicle door that is openable and closable with respect to the vehicle frame;
a housing including a base plate that abuts and is affixed to a rear end panel of the vehicle door, the base plate having an entry opening extending in a first direction and configured to receive the striker, the entry opening having an entrance located at a first end of the entry opening in the first direction and a base located at a second end of the entry opening in the first direction;
a fork pivotably provided on the base plate such that the fork is pivotable about a fork axis to a latched position, where the fork retains the striker in the entry opening, and to an unlatched position, where the fork allows the striker to separate from the entry opening;
a pawl pivotably provided on the base plate so as to be pivotable about a pawl axis, the pawl being configured to move so as to fix or release the fork; and
an actuating mechanism provided in the housing and being configured to act on the pawl to cause the pawl to release the fork;
wherein:
the base plate has a first attachment hole, a second attachment hole, and a third attachment hole,
first, second and third fasteners are inserted through the rear end panel and fastened in the first, second and third attachment holes, respectively,
a second direction is orthogonal to the first direction and is parallel to the base plate,
the first attachment hole is located on a first side of the entry opening in the second direction,
the second and third attachment holes are located on a second side of the entry opening in the second direction,
the second side of the entry opening is opposite of the first side of the entry opening in the second direction,
the fork axis is disposed on the first side of the entry opening in the second direction and the pawl axis is disposed on the second side of the entry opening in the second direction,
the first and second attachment holes are located closer to the entrance of the entry opening than the fork axis in the first direction, and
the third attachment hole is located between the base of the entry opening and the fork axis in the first direction.

12. The vehicle according to claim 11, wherein:
the first attachment hole is spaced farther away from the entry opening than the fork axis in the second direction,
the second attachment hole is spaced farther away from the entry opening than the pawl axis in the second direction, and
the third attachment hole is spaced farther away from the entry opening than the pawl axis in the second direction.

13. The vehicle according to claim 12, wherein:
a center of the first attachment hole is spaced apart from a center of the third attachment hole by a first distance,
the center of the first attachment hole is spaced apart from a center of the second attachment hole by a second distance, and
the first distance is equal to or less than the second distance.

14. The vehicle according to claim 13, wherein:
a peripheral edge section is located on a side of the base plate that is opposite of the entrance of the entry opening in the first direction,
the peripheral edge section extends along the second direction and includes a bent section that is bent in a third direction and also extends along the second direction, and
the third direction is at least substantially orthogonal to both the first direction and the second direction.

15. The vehicle according to claim 14, wherein the bent section is curved or angled such that first and second ends of the bent section in the second direction are closer, in the first direction, to the entrance of the entry opening than an intermediate section located between the first and second ends of the bent section in the second direction.

16. The vehicle according to claim 15, wherein:
the first end of the bent section is spaced farther away from the entry opening than the third attachment hole in the second direction, and
the second end of the bent section is spaced farther away from the entry opening than the fork axis in the second direction.

17. An apparatus comprising:
a housing including a base plate configured to abut and be affixed to a vehicle door, the base plate having an entry opening extending in a first direction and configured to receive a striker affixed to a vehicle frame, the entry opening having an entrance located at a first end of the entry opening in the first direction and a base located at a second end of the entry opening in the first direction;
a fork pivotably provided on the base plate such that the fork is pivotable about a fork axis to a latched position, where the fork retains the striker in the entry opening, and to an unlatched position, where the fork allows the striker to separate from the entry opening;
a pawl pivotably provided on the base plate so as to be pivotable about a pawl axis, the pawl being configured to move so as to fix or release the fork; and
an actuating mechanism provided in the housing and being configured to act on the pawl to cause the pawl to release the fork;
wherein:
the base plate has a first attachment hole, a second attachment hole, and a third attachment hole configured to respectively receive first, second and third fasteners,
a second direction is orthogonal to the first direction and is parallel to the base plate,
the first attachment hole is located on a first side of the entry opening in the second direction,
the second and third attachment holes are located on a second side of the entry opening in the second direction,
the second side of the entry opening is opposite of the first side of the entry opening in the second direction,
the fork axis is disposed on the first side of the entry opening in the second direction and the pawl axis is disposed on the second side of the entry opening in the second direction,
the first and second attachment holes are located closer to the entrance of the entry opening than the fork axis in the first direction, and
the third attachment hole is located between the base of the entry opening and the fork axis in the first direction.

18. The apparatus according to claim 17, wherein:
the first attachment hole is spaced farther away from the entry opening than the fork axis in the second direction,
the second attachment hole is spaced farther away from the entry opening than the pawl axis in the second direction, and
the third attachment hole is spaced farther away from the entry opening than the pawl axis in the second direction.

19. The apparatus according to claim 17, wherein:
a center of the first attachment hole is spaced apart from a center of the third attachment hole by a first distance,
the center of the first attachment hole is spaced apart from a center of the second attachment hole by a second distance, and
the first distance is equal to or less than the second distance.

20. The apparatus according to claim 17, wherein:
a peripheral edge section is located on a side of the base plate that is opposite of the entrance of the entry opening in the first direction,
the peripheral edge section extends along the second direction and includes a bent section that is bent in a third direction and also extends along the second direction, and
the third direction is at least substantially orthogonal to both the first direction and the second direction.
